(19) United States
(12) Patent Application Publication
(10) Pub. No.: US 2026/0059343 A1
(43) Pub. Date: Feb. 26, 2026

(54) SYSTEMS AND METHODS FOR AUTOMATED DEPLOYMENT OF CELL SITES IN A WIRELESS NETWORK

(71) Applicant: Verizon Patent and Licensing Inc., Basking Ridge, NJ (US)

(72) Inventor: Sanjay Vyas, Miyapur (IN)

(73) Assignee: Verizon Patent and Licensing Inc., Basking Ridge, NJ (US)

(21) Appl. No.: 18/810,443

(22) Filed: Aug. 20, 2024

(51) Int. Cl. H04W 16/18; H04W 16/22

(52) U.S. Cl. CPC H04W 16/18; H04W 16/22

(57) ABSTRACT

A system described herein may receive configuration information and Key Performance Indicator ("KPI") monitoring information from a plurality of cell sites of a wireless network, based on which a plurality of cell site models may be generated. The cell site models may be scored and ranked based on the KPI monitoring information for each cell site model and further based on optimization factors. A first ranking of the cell site models includes may be based on a first optimization factor and a second ranking may be based on a second optimization factor. The system may select, based on comparing a requested optimization factor to the optimization factors, the first optimization factor, and may identify the first ranking. The system may select the particular cell site model based on the first score; identify configuration information included in the cell site model; and implement a cell site based on the configuration information.

### BACKGROUND

Wireless networks provide wireless connectivity to User Equipment ("UEs"), such as mobile telephones, tablets, Internet of Things ("IoT") devices, Machine-to-Machine ("M2M") devices, or the like. Wireless networks may include radio access network ("RANs") that provide a wireless interface between UEs and a core of the wireless networks, where the core provides functionality such as access control, Quality of Service ("QoS") policy management and enforcement, routing services, and so on. RANs may include and/or may be implemented by wireless network infrastructure equipment located at geographically distributed locations, in order to provide wireless coverage to such areas.

### BRIEF DESCRIPTION OF THE DRAWINGS

FIG. 1 illustrates an example overview of one or more embodiments described herein;

FIGS. 2 and 3 illustrate an example of generating cell site optimization models that are associated with various optimization factors, in accordance with some embodiments;

FIG. 4 illustrates an example of selecting a particular cell site optimization model to fulfill a request to implement or modify a cell site of a wireless network, in accordance with some embodiments;

FIG. 5 illustrates an example of generating multiple optimization scores for different cell site models, in accordance with some embodiments;

FIG. 6 illustrates an example process for automatically implementing or configuring a cell site of a wireless network in accordance with embodiments described herein, in accordance with some embodiments;

FIGS. 7 and 8 illustrate example environments in which one or more embodiments, described herein, may be implemented;

FIG. 9 illustrates an example arrangement of a RAN, in accordance with some embodiments;

FIG. 10 illustrates an example arrangement of an Open RAN ("O-RAN") environment in which one or more embodiments, described herein, may be implemented; and

FIG. 11 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Wireless networks may deploy wireless network infrastructure equipment, such as base stations, routers, switches, processing units, and/or otherwise hardware resources that may be used to implement a RAN of a wireless network. For example, a particular set of wireless network infrastructure equipment (e.g., which may correspond to one or more base stations, backhaul routers, cell site routers, etc.) may be deployed, installed, etc. at a first location (e.g., to provide wireless connectivity to UEs within a coverage area associated with the first location), and another set of wireless network infrastructure equipment may be deployed, installed, etc. at a second location. In this manner, wireless connectivity may be provided throughout a relatively wide area, such as to a region, a city, a state, a country, etc. A particular "cell site," as referred to herein, may include the wireless network infrastructure equipment deployed at a particular location. For example, a first cell site may include a first set of wireless network infrastructure equipment deployed at a first location, while a second cell site may include a second set of wireless network infrastructure equipment deployed at a second location.

Designing and/or configuring cell sites (e.g., in order to serve additional regions and/or to enhance wireless connectivity within a region that already receives wireless connectivity from the RAN) may be a relatively laborious task, as numerous factors may come into play that may ultimately influence the configuration or deployment parameters of a given cell site. For example, factors such as coverage area (e.g., distance of coverage from a given cell site, amount of area receiving wireless service from the cell site, etc.), reliability (e.g., health parameters within a nominal range and/or below thresholds such as maximum temperature thresholds, reliability metrics such as uptime and/or downtime, etc.), performance (e.g., latency, throughput, etc.), locale-specific parameters (e.g., terrain features, air quality, building density, etc.), may influence configuration and/or deployment parameters such as types of hardware equipment to install at a cell site, QoS parameters (e.g., weighting parameters, priority parameters, etc.), and/or other suitable parameters.

Embodiments described herein provide for an automated determination of cell site configuration and/or deployment parameters (e.g., when deploying a new cell site or modifying an existing one), such that the cell site is able to provide service in a manner that optimizes one or more particular factors. Some embodiments provide for the automated determination of factors, for a given cell site, that should be optimized. In some embodiments, some or all of the techniques described herein may be performed using artificial intelligence/machine learning ("AI/ML") techniques or other suitable automated techniques.

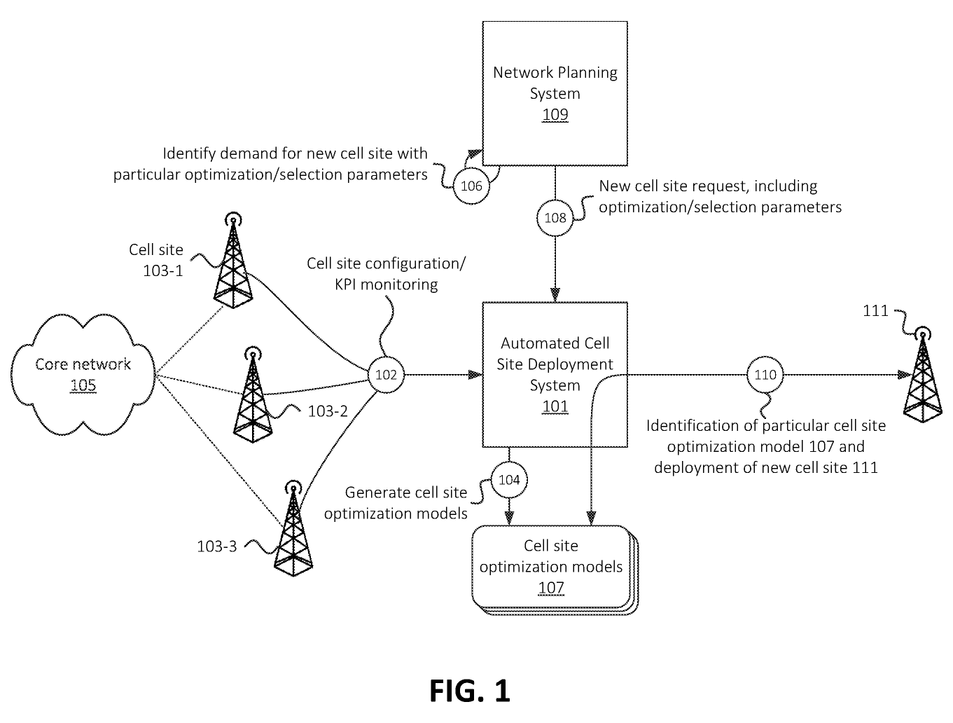

As shown in FIG. 1, some embodiments may include Automated Cell Site Deployment System ("ACSDS") 101, which may receive (at 102) cell site configuration information, Key Performance Indicator ("KPI") monitoring information, and/or other information associated with one or more cell sites 103 (e.g., example cell sites 103-1, 103-2, and 103-3). As noted above, cell sites 103 may include, may implement, or may otherwise be associated with one or more base stations, routing devices, or other suitable devices or systems associated with a RAN of a wireless network. For example, cell sites 103 may provide a wireless interface to UEs that are communicatively coupled to wireless network infrastructure equipment of cell sites 103 (e.g., to base stations of cell sites 103), thus allowing such UEs to communicate with a core network 105. As noted above, core network 105 may provide routing services, authorization services, QoS services, or other suitable services relating to traffic sent to or from the UEs via a given cell site 103.

ACSDS 101 may be communicatively coupled to one or more cell sites 103 via an application programming interface ("API") and/or some other suitable interface. In some embodiments, ACSDS 101 may receive (at 102) cell site configuration information and/or KPI monitoring information from some other device or system that aggregates, determines, and/or provides such information.

Cell sites 103 may each include, may be communicatively coupled to, etc. one or more backhaul links, cell site routers, hubs, switches, etc., via which cell sites 103 communicate with core network 105. Such links, cell site routers, etc. may have configurable parameters, may have particular attributes or specifications (e.g., processor or chipset types, port configurations, QoS weighting configurations, etc.) that impact the functionality and/or capability of the links, cell site routers, etc.

Cell sites 103 may also include, may be communicatively coupled to, etc. include wireless network infrastructure equipment such as radios, antennas, baseband units, radio units ("RUs"), Distributed Units ("DUs"), or the like, via which cell sites 103 may wirelessly communicate with (e.g., provide wireless service to) UEs that are within communications range of such wireless network infrastructure equipment. Providing wireless service via the wireless network infrastructure equipment may include parameters such as resource allocation parameters, QoS parameters, beamforming parameters (e.g., antenna or beam direction, antenna transmit power, etc.), Multiple-Input Multiple-Output ("MIMO") parameters, scheduling and/or weighting parameters, or other suitable configurable parameters. Such parameters may be configurable on a per-cell site basis in order to optimize or improve operations of a given cell site 103 (e.g., to improve coverage of cell site 103, to improve performance of cell site 103, etc.). Such parameters may impact the functionality such as QoS functionality, access control functionality, etc. of cell sites 103 when providing wireless connectivity to UEs.

Cell sites 103 may, in some embodiments, be implemented by particular hardware resources, such as dedicated server devices or other types of devices. Additionally, or alternatively, cell sites 103 may be implemented by virtualized and/or containerized systems, in which one or more virtual machines may be implemented by physical hardware resources (e.g., co-located hardware resources and/or cloud hardware resources). Cell sites 103 may accordingly be associated with hardware resource parameters or attributes of hardware resources that are used to implement cell sites 103. Such hardware resource parameters may include, for example, processor or chipset type, memory space, storage space, types or quantities of network interfaces, or the like. In some embodiments, hardware resource parameters may include virtualization or containerization parameters such as images or containers that each implement specific functionality of cell sites 103 (e.g., functionality of a DU, functionality of an RU, etc.).

In some embodiments, configuration information associated with a given cell site 103 may include communication and/or routing information, such as Internet Protocol ("IP") subnet information, IP assignment information such as Dynamic Host Configuration Protocol ("DHCP") information, or the like. Such communication information may be used for internal communications between elements of cell site 103 (e.g., wireless network infrastructure equipment, backhaul links, cell site routers, etc.).

KPI monitoring information, associated with cell sites 103, may include performance KPIs, health and/or operational status KPIs, utilization and/or load KPIs, power consumption KPIs, and/or other types of values, scores, etc. that may potentially vary from time to time. Generally, the KPIs may be used to identify whether cell sites 103 are meeting QoS thresholds such as latency thresholds or throughput thresholds, are meeting Service Level Agreements ("SLAs"), are within nominal operating parameters, etc. Nominal operating parameters may include or may be based on "health" parameters such as temperature of hardware resources implementing one or more elements of cell site 103 (e.g., whether such hardware resources are below a threshold temperature or are within a given temperature range), power-related metrics such as amount of power consumed or input voltage, alarm or alert history (e.g., which may be triggered by one or more health thresholds being exceeded), or other suitable information.

In some embodiments, ACSDS 101 may receive or monitor one or more other types of information associated with one or more cell sites 103, such as locale features of coverage areas served by respective cell sites 103. Locale features may include, for example, an indicator or label of locale type (e.g., city, suburban, densely populated, highway, concert venue, sporting venue, etc.), air quality information (e.g., particulate matter 2.5 ("PPM2.5") information), weather information, altitude, or other information associated with a geographical region in which hardware elements of one or more cell sites 103 are deployed and/or a geographical region that receives wireless coverage from one or more cell sites 103.

In some embodiments, ACSDS 101 may receive (at 102) the cell cite configuration information and/or KPI monitoring associated with cell sites 103 on a periodic basis and/or on some other ongoing basis. In this sense, ACSDS 101 may receive up-to-date configuration information (e.g., in situations where the configuration of cell site 103 changes) and/or KPI reporting information associated with one or more cell sites 103. While examples of cell site configuration information are provided above, in practice, other types of cell site configuration information may be provided to ACSDS 101. In some embodiments, the cell site configuration information and/or KPI monitoring information may be received (at 102) during the course of operation of one or more physical cell sites 103 that have been deployed at a physical location and that provide wireless access to physical UEs. Additionally, or alternatively, in some embodiments, the cell site configuration information and/or KPI monitoring information may be received pursuant to one or more simulations that are performed using models or other simulation techniques, that simulate the operation of one or more cell sites 103.

Based on the received cell site configuration information and/or KPI monitoring information, and further based on techniques described herein, ACSDS 101 may generate and/or modify (at 104) one or more cell site optimization models 107. For example, as described in more detail below, cell site optimization models 107 may include configuration parameters for cell sites that have been optimized for various factors, attributes, and/or criteria. Such factors, attributes, or criteria may include, for example, expected demand for service at a given location (e.g., where "demand" may be denoted in terms of quantity of UEs, amount of traffic, or some other measure of demand), hardware resources available or required to implement a new cell site at a given location, topographical and/or geographical features of a given location, etc.

For example, the given location may correspond to a location at which a new cell site is to be installed, deployed, instantiated, etc. For example, Network Planning System ("NPS") 109 may identify (at 106) a demand for a new cell site (e.g., at a particular location). For example, NPS 109 may utilize AI/ML techniques or other suitable techniques to identify a demand for a new cell site at a particular location, which may include determining that wireless coverage metrics at the particular location are below one or more threshold wireless coverage metrics (e.g., signal strength and/or quality at the particular location are below threshold signal strength and/or quality thresholds). As another example, identifying the demand for the new cell site may include determining that existing cell sites 103 that are at or near the particular location are unable to provide enough throughput to UEs that are located at, or may potentially be located at, the particular location. In other examples, NPS 109 may identify (at 106) the demand for the new cell site based on one or more other factors.

NPS 109 may further identify (at 106) particular optimization and/or selection parameters for the new cell site. For example, NPS 109 may identify that the new cell site should be able to accommodate at least a threshold quantity of UEs, may identify particular QoS parameters for the new cell site (e.g., QoS thresholds to be met by the new cell site such as latency and/or throughput thresholds), may identify hardware constraints for the new cell site (e.g., a minimum and/or maximum set of hardware resources available to implement the new cell site, may identify locale features of the new cell site (e.g., topographical features, weather patterns, location type, etc.), and/or other hardware-related constraints or parameters), and/or may identify other parameters or criteria for the new cell site.

NPS 109 may further output (at 108) a request to ACSDS 101, indicating that a new cell site should be deployed (e.g., at a particular location, and/or to provide wireless service at a particular location or area). The request may further indicate the optimization and/or selection parameters determined (at 106) by NPS 109 with respect to the new cell site, such as minimum or maximum hardware resource specifications, QoS thresholds, locale features, or the like. ACSDS 101 may compare the optimization and/or selection parameters of the requested new cell site to some or all of the cell site optimization models 107. For example, ACSDS 101 may utilize AI/ML techniques or other suitable techniques to identify a "matching" cell site optimization model 107 for the request. Generally, the selected cell site optimization model 107 (e.g., the cell site optimization model 107 that "matches" the optimization and/or selection parameters) may indicate the same, or similar (e.g., having at least a threshold measure of similarity, pursuant to a suitable similarity analysis), attributes as the optimization and/or selection parameters. Generally, the selected cell site optimization model 107 may best meet, match, etc. the requested optimization and/or selection parameters, in order to achieve the optimization goals determined by NPS 109 with respect to the new cell site (e.g., to meet UE demand for wireless service at the particular location).

As one example, assume that cell site 103-1 serves a relatively large quantity of UEs and is associated with an "office building" locale type. Further assume that cell site 103-2 serves a relatively small quantity of UEs and is associated with a "highway" locale type. In an example where the request (at 108) indicates that a new cell site is to be deployed at an "office building" locale type and should serve a relatively large quantity of UEs, a particular cell site optimization model 107 that has been generated based on cell site 103-1 (e.g., which is associated with an "office building" locale type and which is capable of serving a relatively large quantity of UEs) may be selected. Selecting the particular cell site optimization model 107 may further include identifying configuration and/or deployment parameters included in cell site optimization model 107, such that these configuration and/or deployment parameters may be used to deploy (at 110) new cell site 111.

For example, the selected cell site optimization model 107 may include containers, installation packages, configuration parameters, hardware resource specifications, and/or other suitable information that may be used to deploy a new cell site (e.g., cell site 111) that matches a particular cell site 103 on which cell site optimization model 107 is based. ACSDS 101 may proceed to deploy cell site 111, which may include communicating with a virtualization and/or containerization system to implement particular devices or elements of cell site 111, and/or otherwise causing cell site 111 to be implemented. In this manner, cell site 111 may be designed and configured to optimally provide service in the particular location (e.g., according to optimization parameters selected by NPS 109), and further reduces or eliminates the need for manual design and/or configuration. Further, in some embodiments, ACSDS 101 may continue to monitor cell sites 103 and/or cell site 111 to determine whether optimization parameters such as QoS thresholds are being met, and may continue to modify the configuration and/or deployment of cell sites 103 and/or cell site 111 in order to optimize cell sites 103 and cell site 111 in accordance with respective optimization parameters.

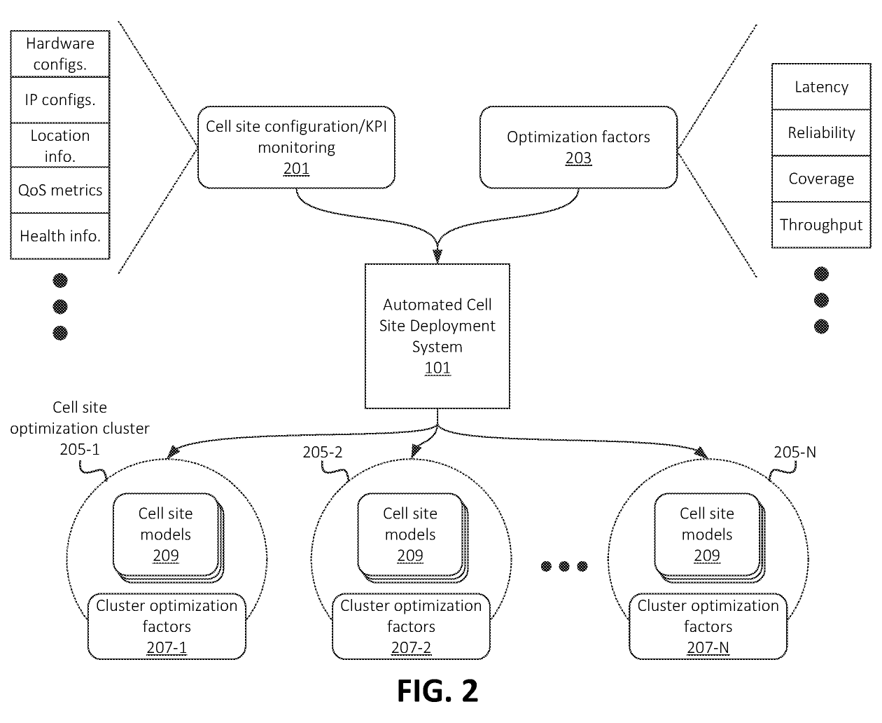

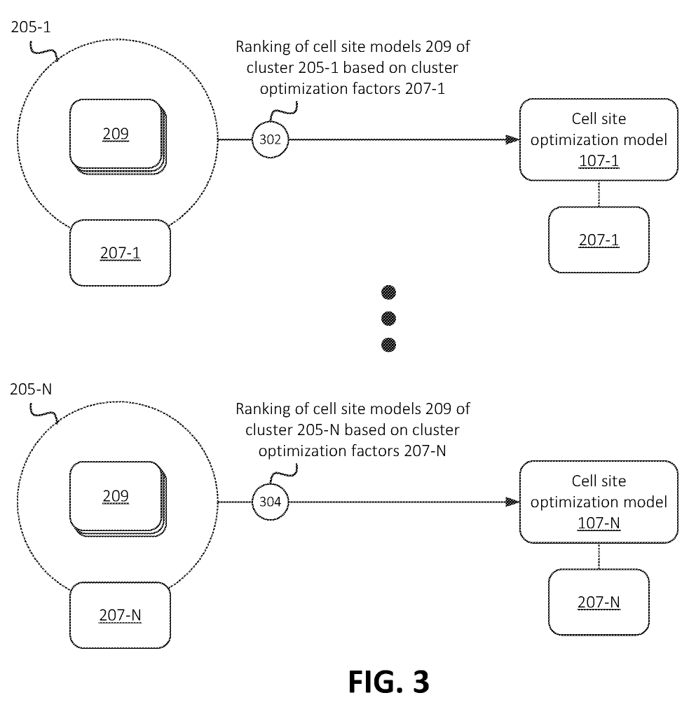

FIGS. 2 and 3 illustrate an example of generating cell site optimization models 107, in accordance with some embodiments. As noted above, ACSDS 101 may receive (e.g., at 102) cell site configuration information and/or KPI monitoring information 201 associated with one or more cell sites 103. As also discussed above, cell site configuration and/or KPI monitoring information 201 for a given cell site 103 may include information such as hardware configuration information, IP configuration information, locale information, QoS metrics, health information, and/or other suitable information.

In some embodiments, ACSDS 101 may also determine or receive a set of optimization factors 203. Optimization factors 203 may be factors based on which ACSDS 101 may cluster, score, evaluate, etc. different cell sites and/or cell cite configurations, in accordance with some embodiments. For example, as shown, ACSDS 101 may generate a set of cell site optimization clusters 205 (e.g., cell site optimization clusters 205-1, 205-2, and 205-N) that are each associated with a respective set of cluster optimization factors 207. In the example of FIG. 2, cell site optimization cluster 205-1 is associated with cluster optimization factors 207-1, cell site optimization cluster 205-2 is associated with cluster optimization factors 207-2, and cell site optimization cluster 205-N is associated with cluster optimization factors 207-N.

The different cluster optimization factors 207 may include different sets of optimization factors 203, and/or may include different weights or priorities of different optimization factors 203. For example, cluster optimization factors 207-1 may include optimization factors such as low latency and high throughput (e.g., a relative low latency threshold and a relative high throughput threshold), while cluster optimization factors 207-2 may include optimization factors such as high UE load (e.g., the capacity to provide service to a relative high quantity of UEs).

ACSDS 101 may associate cell site models 209 with respective cell site optimization clusters 205, such that each cell site optimization cluster 205 includes one or more cell site models 209. In some embodiments, the same cell site model 209 may be placed into multiple clusters. A given cell site model 209, as referred to herein, may include or may be based on cell site configuration and/or KPI monitoring information 201 for a given cell site 103. For example, a first cell site model 209 may include (or may be based on) configuration information and/or KPI monitoring information associated with a first cell site 103, a second cell site model 209 may include (or may be based on) configuration information and/or KPI monitoring information associated with a second cell site 103, and so on. In some embodiments, each cell site optimization cluster 205 may include cell site models 209 for all cell sites 103 for which ACSDS 101 has received (e.g., at 102) cell site configuration and/or KPI monitoring information 201. In some embodiments, each cell site optimization cluster 205 may include cell site models 209 for fewer than all cell sites 103 for which ACSDS 101 has received cell site configuration and/or KPI monitoring information 201. As noted above, in some embodiments, cell site optimization clusters 205 may be non-exclusive, inasmuch as the same cell site model 209 may be included in or associated with multiple cell site optimization clusters 205.

As shown in FIG. 3, for each cell site optimization cluster 205, ACSDS 101 may rank, score, evaluate, etc. the cell site models 209 of each cell site optimization cluster 205, based on the respective cluster optimization factors 207 associated with each cell site optimization cluster 205. For example, ACSDS 101 may rank (at 302) cell site models 209 of cell site optimization cluster 205-1 based on cluster optimization factors 207-1, may rank (at 304) cell site models 209 of cell site optimization cluster 205-N based on cluster optimization factors 207-N, and so on. For example, when ranking (at 302) cell site models 209 of cell site optimization cluster 205-1, ACSDS 101 may compare performance KPIs, health KPIs, load KPIs, etc. of cell site models 209 to cluster optimization factors 207-1. For example, as noted above, cluster optimization factors 207-1 may include particular factors, criteria, weights, constraints, etc. based on which ACSDS 101 may rank or score different cell site models 209. Referring to the example above, assume that cluster optimization factors 207-1 specify relatively low latency and relatively high throughput (e.g., a relative low latency threshold and a relative high throughput threshold). Cell site optimization cluster 205-1 may score or rank cell site models 209 based on latency and throughput KPIs indicated in specific cell site models 209 (e.g., based on KPIs received from corresponding cell sites 103).

ACSDS 101 may, in some embodiments, select a particular cell site model 209 that is a highest ranking or scoring cell site model 209 out of the set of cell site models 209 included in cell site optimization cluster 205-1. The selected cell site model 209 may be designated as a particular cell site optimization model 107 (e.g., cell site optimization model 107-1) that is associated with cluster optimization factors 207-1. Additionally, or alternatively, ACSDS 101 may generate a new cell site optimization model 107 based on one or more cell site models 209 included in cell site optimization cluster 205-1. For example, ACSDS 101 may utilize AI/ML techniques to generate cell site optimization model 107-1 based on a set of highest scoring cell site models 209 of cell site optimization cluster 205-1 (e.g., may combine or aggregate configuration parameters of cell sites 103 with which such cell site models 209 are associated). Similarly, ACSDS 101 may identify a highest ranking cell site model 209 of cell site optimization cluster 205-N as the cell site optimization model 107-N for cluster optimization factors 207-N, and/or may generate a new cell site optimization model 107-N based on scoring or ranking cell site models 209 of cell site optimization cluster 205-N.

While an example of clustering and/or ranking is discussed above, in practice, other suitable techniques may be used to identify respective cell site optimization models 107 that are associated with respective cluster optimization factors 207. For example, multi-dimensional techniques may be used to identify cell site optimization models 107 that are optimized for multiple cluster optimization factors 207, and/or that would meet other criteria or constraints of a request for a new cell site such as locale features, available hardware resources (e.g., in order to avoid situations where a cell cite configuration is selected that is unfeasible with available hardware resources), or the like.

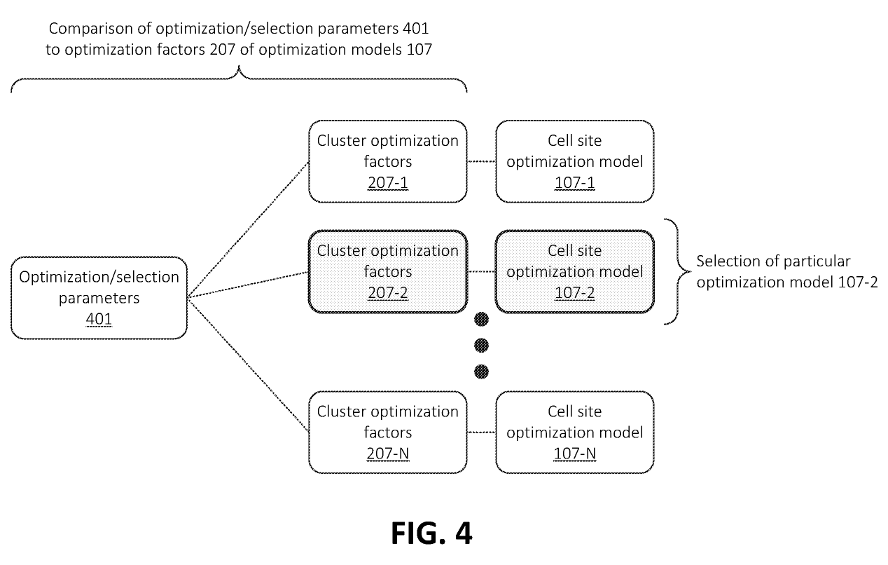

As shown in FIG. 4, and as referred to in FIG. 1, ACSDS 101 may select a particular cell site optimization model 107 in response to a request to establish, instantiate, deploy, etc. a new cell site. As noted above, the request (e.g., from NPS 109) may specify a set of optimization and/or selection parameters 401 for a new cell site. ACSDS 101 may compare optimization and/or selection parameters 401 to cluster optimization factors 207 to identify a particular set of cluster optimization factor 207 that most closely match optimization and/or selection parameters 401. As similarly noted above, the "match" may include an exact match, or may be based on a similarity analysis that indicates a measure of similarity between optimization and/or selection parameter 401 and each set of cluster optimization factors 207. In this example, assume that ACSDS 101 determines that cluster optimization factors 207-2 most closely match optimization and/or selection parameters 401. For example, the factors based on which cell site optimization model 107-2 has been selected or identified may most closely align with the optimization objectives of optimization and/or selection parameters 401, as compared to the other sets of cell site optimization models 107. For example, optimization and/or selection parameters 401 may specify that a larger coverage area is specified for the new cell site, and cluster optimization factors 207-2 may include coverage area as a primary optimization factor (e.g., a highest weighted optimization factor, or a relatively highly weighted optimization factor). ACSDS 101 may accordingly identify that cell site optimization model 107-2 is associated with cluster optimization factors 207-2, and may accordingly select cell site optimization model 107-2 for implementation at the new cell site 111.

When selecting cell site optimization model 107-2, ACSDS 101 may also take into consideration other factors, such as hardware resource specifications indicated in optimization and/or selection parameter 401, locale features specified in optimization and/or selection parameter 401, etc. Thus, as noted above, when identifying a set of cluster optimization factors 207 that match optimization and/or selection parameters 401, ACSDS 101 may further utilize the additional factors as constraints, criteria, etc. In one example, cluster optimization factors 207-N may provide for a greater measure of optimization of a given factor (e.g., coverage area, latency, throughput, etc.) than cluster optimization factors 207-2. However, cell site optimization model 107-N may specify hardware resources that are incompatible with (e.g., require greater amounts of resources, require types of hardware resources that are unavailable, etc.) hardware resource specifications included in optimization and/or selection parameters 401.

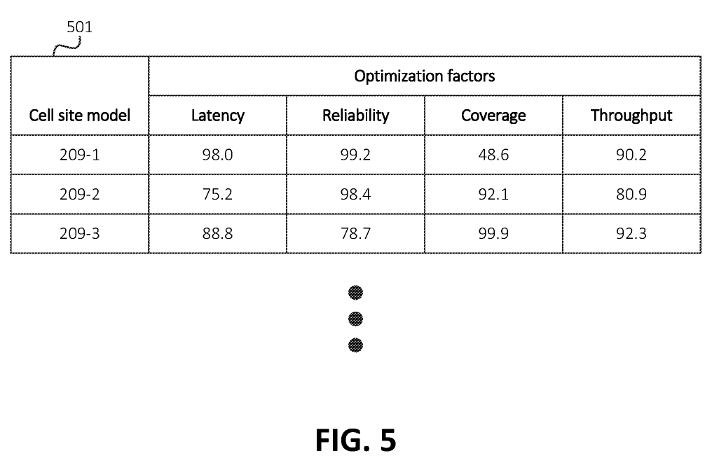

FIG. 5 illustrates another representation of scoring and/or ranking cell site models 209 based on multiple different optimization factors. As shown, data structure 501 may represent scores, for respective optimization factors, that have been generated by ACSDS 101 with respect to one or more cell site models 209 (i.e., cell site models 209-1, 209-2, and 209-3 in this example). For example, a first cell site model 209-1 may be associated with a first score for latency, a first score for reliability, a first score for coverage, and a first score for throughput. Additionally, a second cell site model 209-2 may be associated with a second score for latency, a second score for reliability, a second score for coverage, and a second score for throughput. Further, a third Additionally, a second cell site model 209-3 may be associated with a third score for latency, a third score for reliability, a third score for coverage, and a third score for throughput. The scores may be normalized (e.g., set to the same scale, such as a scale of 1-100 or some other suitable scale) and/or otherwise derived from raw KPIs. In some embodiments, in addition to or in lieu of scores, optimization factors for one or more cell site models 209 may be represented in terms of raw KPI values, such as latency metrics (e.g., average, median, etc. measures of latency over time), throughput metrics (e.g., average, median, etc. measures of throughput over time), or the like. Further, while example optimization factors are shown in FIG. 5, cell site models 209 may, in practice, be associated with scores or other suitable values for additional, fewer, or different optimization factors.

As such, a first ranking (e.g., a ranking based on latency metrics) may indicate that cell site model 209-1 is a highest ranked cell site model with respect to latency metrics, that cell site model 209-3 is a second highest ranked cell site model with respect to latency metrics, and that cell site model 209-2 is a third highest ranked cell site model with respect to latency metrics. Similarly, a second ranking (e.g., a ranking based on reliability metrics) may indicate that cell site model 209-1 is a highest ranked cell site model with respect to reliability metrics, that cell site model 209-2 is a second highest ranked cell site model with respect to reliability metrics, and that cell site model 209-3 is a third highest ranked cell site model with respect to reliability metrics.

As noted above, scores or other values may be generated to reflect combinations of different optimization factors. For example, a "latency and reliability" score for cell site model 209-1 may be generated based on averaging or otherwise combining the latency score and the reliability score for cell site model 209-1. In this instance, the "latency and reliability" score for cell site model 209-1 may be 98.6 (the average of 98.0 and 99.2). As another example, a weighted "70% latency and 30% reliability" score may be 98.36 (i.e., may be generated via the following calculation: 98.0*.7 + 99.2*.3).

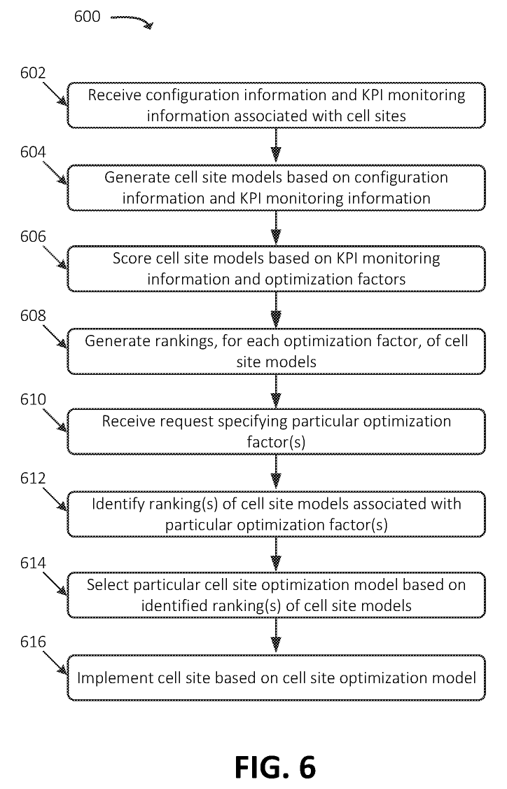

FIG. 6 illustrates an example process 600 for automatically implementing or configuring a cell site of a wireless network in accordance with embodiments described herein. In some embodiments, some or all of process 600 may be performed by ACSDS 101. In some embodiments, one or more other devices may perform some or all of process 600 in concert with, and/or in lieu of, ACSDS 101.

As shown, process 600 may include receiving (at 602) configuration information and KPI monitoring information associated with one or more cell sites 103. For example, as discussed above, ACSDS 101 may receive cell site configuration and/or KPI monitoring information 201 from (or otherwise associated with) one or more cell sites 103 of a wireless network. ACSDS 101 may, in some embodiments, receive cell site configuration and/or KPI monitoring information 201 on an ongoing basis in order to maintain up-to-date information regarding cell sites 103.

Process 600 may further include generating (at 604) cell site models 209 based on the received cell site configuration and/or KPI monitoring information 201. For example, ACSDS 101 may generate a respective cell site model 209 for each cell site 103, such that a given cell site model 209 includes or is based on cell site configuration and/or KPI monitoring information 201 for a given cell site 103. Additionally, or alternatively, a particular cell site model 209 may be generated based on cell site configuration and/or KPI monitoring information 201 for multiple cell sites 103 (e.g., including average or otherwise combined KPI information for cell sites 103 with the same or similar configuration).

Process 600 may additionally include scoring (at 606) cell site models 209 based on the KPI monitoring information and one or more optimization factors. For example, as discussed above, ACSDS 101 may generate one or more scores or other suitable values for each cell site model 209 based on KPIs associated with each cell site model 209. The scores may, for example, each be based on one or more optimization factors 203, such as latency, reliability, coverage, throughput, and/or other suitable factors. As noted above, a given score for a given cell site model 209 may be based on multiple optimization factors 203, which may include weighted scores that more heavily weight one or more particular optimization factors 203.

Process 600 may also include generating (at 608) rankings, for each optimization factor, of cell site models 209. For example, ACSDS 101 may rank each cell site model 209 on the basis of one or more different optimization factors or combinations thereof. In this manner, a given cell site model 209 may be associated with multiple rankings (e.g., may be ranked relatively high for one optimization factor 203, and may be ranked relatively low for another optimization factor 203). As discussed above, ranking cell site models 209 may include identifying a highest ranked cell site model 209 for one or more optimization factors or combinations thereof and designating the highest ranked cell site model 209 as the cell site optimization model 107 for such optimization factors or combinations thereof. Additionally, or alternatively, ACSDS 101 may generate a new cell site optimization model 107 for one or more optimization factors based on aggregating or combining multiple cell site models 209 (e.g., the highest ranking cell site models 209 for one or more optimization factors). In some embodiments, ACSDS 101 may utilize AI/ML techniques in selecting or generating a given cell site optimization model 107.

Process 600 may further include receiving (at 610) a request that specifies one or more optimization factors. For example, ACSDS 101 may receive a request from NPS 109 and/or some other suitable source, indicating one or more optimization factors for a cell site (e.g., a new cell site to be deployed, and/or an existing cell site to be modified). As discussed above, the optimization factors included in the request may have been identified based on AI/ML techniques or other suitable techniques.

Process 600 may additionally include identifying (at 612) one or more particular rankings that correspond to the optimization factor(s) specified in the request, and selecting (at 614) a particular cell site optimization model 107 based on the identified ranking(s). For example, as discussed above, ACSDS 101 may identify or generate a particular cell site optimization model 107 that has been designated for optimization factors that match the requested optimization factors.

Process 600 may further include implementing (at 616) cell site 111 based on the selected cell site optimization model 107. For example, ACSDS 101 may provide configuration information, included in cell site optimization model 107, to a provisioning system, a virtualized environment management system, and/or some other suitable device or system that is able to deploy cell site 111 and/or modify an existing cell site 103 with the configuration information included in cell site optimization model 107. As such, the deployed cell site 111 and/or modified cell site 103 may optimally provide wireless coverage to UEs in the wireless network in an automated fashion.

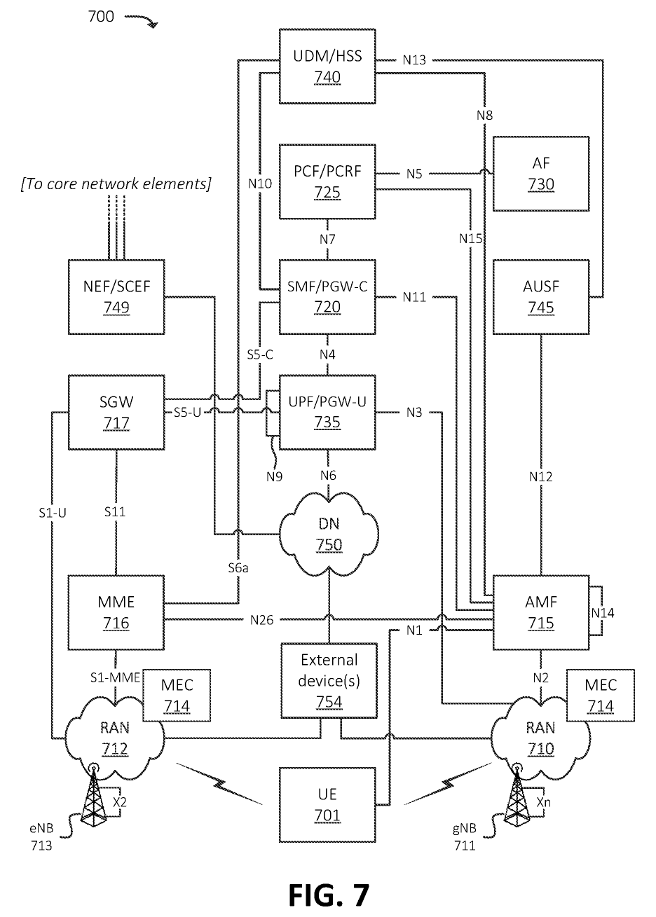

FIG. 7 illustrates an example environment 700, in which one or more embodiments may be implemented. In some embodiments, environment 700 may correspond to a Fifth Generation ("5G") network, and/or may include elements of a 5G network. In some embodiments, environment 700 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 700 may represent or may include a 5G core ("5GC"). As shown, environment 700 may include UE 701, RAN 710 (which may include one or more Next Generation Node Bs ("gNBs") 711), RAN 712 (which may include one or more evolved Node Bs ("eNBs") 713), and various network functions such as Access and Mobility Management Function ("AMF") 715, Mobility Management Entity ("MME") 716, Serving Gateway ("SGW") 717, Session Management Function ("SMF")/Packet Data Network ("PDN") Gateway ("PGW")-Control plane function ("PGW-C") 720, Policy Control Function ("PCF")/Policy Charging and Rules Function ("PCRF") 725, Application Function ("AF") 730, User Plane Function ("UPF")/PGW-User plane function ("PGW-U") 735, Unified Data Management ("UDM")/Home Subscriber Server ("HSS") 740, Authentication Server Function ("AUSF") 745, and Network Exposure Function ("NEF")/Service Capability Exposure Function ("SCEF") 749. Environment 700 may also include one or more networks, such as Data Network ("DN") 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple "slices" of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service ("QoS") parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions ("VNFs"), Cloud-Native Network Functions ("CNFs"), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes^{®} application programming interface ("API") or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces ("SBIs"), including an Namf interface, an Nudm interface, an Npcf interface, an Nupf interface, an Nnef interface, an Nsmf interface, and/or one or more other SBIs.

UE 701 may include a computation and communication device, such as a wireless mobile communication device that is capable of communicating with RAN 710, RAN 712, and/or DN 750. UE 701 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 701 may send traffic to and/or receive traffic (e.g., user plane traffic) from DN 750 via RAN 710, RAN 712, and/or UPF/PGW-U 735.

RAN 710 may be, or may include, a 5G RAN that implements a 5G RAT and that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., user plane traffic such as voice call traffic, data traffic, messaging traffic, etc.) from UE 701 via the air interface, and may communicate the traffic to UPF/PGW-U 735 and/or one or more other devices or networks. Further, RAN 710 may receive signaling traffic, control plane traffic, etc. from UE 701 via the air interface, and may communicate such signaling traffic, control plane traffic, etc. to AMF 715 and/or one or more other devices or networks. Additionally, RAN 710 may receive traffic intended for UE 701 (e.g., from UPF/PGW-U 735, AMF 715, and/or one or more other devices or networks) and may communicate the traffic to UE 701 via the air interface. In some embodiments, a given cell site 103 may be, may include, and/or may be implemented by one or more gNBs 711.

RAN 712 may be, or may include, an LTE RAN that implements an LTE RAT and that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 701 via the air interface, and may communicate the traffic to UPF/PGW-U 735 (e.g., via SGW 717) and/or one or more other devices or networks. Further, RAN 712 may receive signaling traffic, control plane traffic, etc. from UE 701 via the air interface, and may communicate such signaling traffic, control plane traffic, etc. to MME 716 and/or one or more other devices or networks. Additionally, RAN 712 may receive traffic intended for UE 701 (e.g., from UPF/PGW-U 735, MME 716, SGW 717, and/or one or more other devices or networks) and may communicate the traffic to UE 701 via the air interface. In some embodiments, a given cell site 103 may be, may include, and/or may be implemented by one or more eNBs 713.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing ("MEC") devices (referred to sometimes herein simply as a "MECs") 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 701, via RAN 710 and/or 712. For example, RAN 710 and/or 712 may route some traffic from UE 701 (e.g., traffic associated with one or more particular services, applications, application types, etc.) to a respective MEC 714 instead of to core network elements of 700 (e.g., UPF/PGW-U 735). MEC 714 may accordingly provide services to UE 701 by processing such traffic, performing one or more computations based on the received traffic, and providing traffic to UE 701 via RAN 710 and/or 712. MEC 714 may include, and/or may implement, some or all of the functionality described above with respect to UPF/PGW-U 735, AF 730, one or more application servers, and/or one or more other devices, systems, VNFs, CNFs, etc. In this manner, ultra-low latency services may be provided to UE 701, as traffic does not need to traverse links (e.g., backhaul links) between RAN 710 and/or 712 and the core network.

AMF 715 may include one or more devices, systems, VNFs, CNFs, etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked "N14" originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple instances of UPF/PGW-U 735 may be deployed (e.g., in different geographical locations), and the delivery of content to UE 701 may be coordinated via the N9 interface (e.g., as denoted in FIG. 7 by the line marked "N9" originating and terminating at UPF/PGW-U 735). Similarly, UPF/PGW-U 735 may receive traffic from UE 701 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a Unified Data Repository ("UDR"). AUSF 745 and/or UDM/HSS 740 may perform authentication, authorization, and/or accounting operations associated with one or more UEs 701 and/or one or more communication sessions associated with one or more UEs 701.

DN 750 may include one or more wired and/or wireless networks. For example, DN 750 may include an Internet Protocol ("IP")-based PDN, a wide area network ("WAN") such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network ("PSTN"), a public land mobile network ("PLMN"), and/or another network. DN 750 may be connected to one or more devices, such as content providers, applications, web servers, and/or other devices, with which UE 701 may communicate.

External devices 754 may include one or more devices or systems that communicate with UE 701 via DN 750 and one or more elements of 700 (e.g., via UPF/PGW-U 735). In some embodiments, external devices 754 may include, may implement, and/or may otherwise be associated with ACSDS 101, NPS 109, and/or one or more other devices or systems. External devices 754 may include, for example, one or more application servers, content provider systems, web servers, or the like. External devices 754 may, for example, implement "server-side" applications that communicate with "client-side" applications executed by UE 701. External devices 754 may provide services to UE 701 such as gaming services, videoconferencing services, messaging services, email services, web services, and/or other types of services.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy ("SEPP"), which may perform some or all of the functions discussed above. External device 754 may, in some situations, subscribe to particular types of requested information provided by the one or more core network elements, and the one or more core network elements may provide (e.g., "push") the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements ("SLAs"), etc. (e.g., maximum latency thresholds, minimum throughput thresholds, etc.) associated with the services.

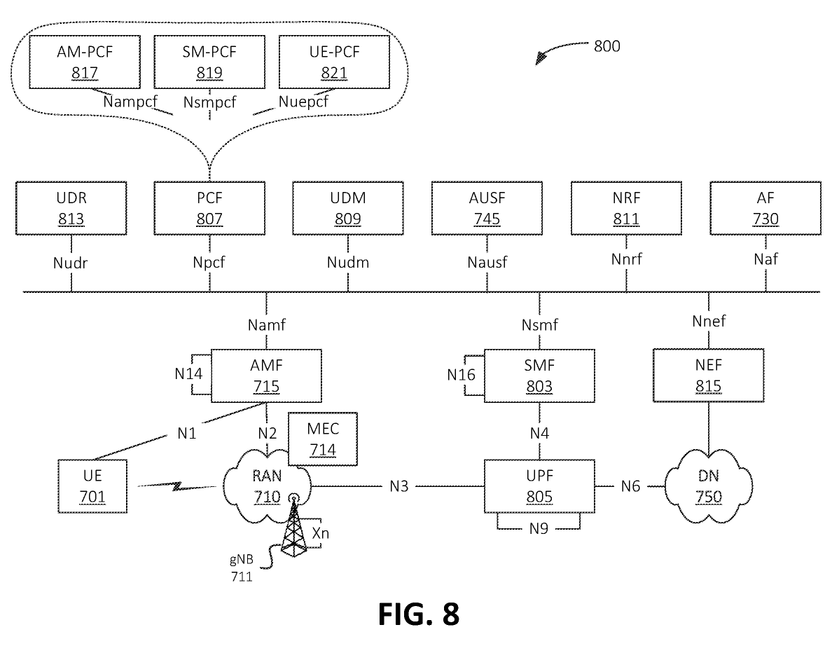

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 701, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function ("NRF") 811, AF 730, UDR 813, and NEF 815. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple "slices" of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs.

UPF 805 may include one or more devices, systems, VNFs, CNFs, etc., that receive, route, process, and/or forward traffic (e.g., user plane traffic). As discussed above, UPF 805 may communicate with UE 701 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 701) from DN 750, and may forward the downlink user plane traffic toward UE 701 (e.g., via RAN 710). In some embodiments, multiple UPFs 805 may be deployed (e.g., in different geographical locations), and the delivery of content to UE 701 may be coordinated via the N9 interface. Similarly, UPF 805 may receive uplink traffic from UE 701 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 701 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as access and mobility PCF ("AM-PCF") 817, session management PCF ("SM-PCF") 819, UE PCF ("UE-PCF") 821, and so on. Such different "split" PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 815 include one or more devices, systems, VNFs, CNFs, etc. that provide access to information, APIs, and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function ("CHF") of the 5GC, and/or other suitable network function. NEF 815 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 815 may include, may implement, may be implemented by, and/or may otherwise be associated with a SCEF (e.g., NEF/SCEF 749); and so on.

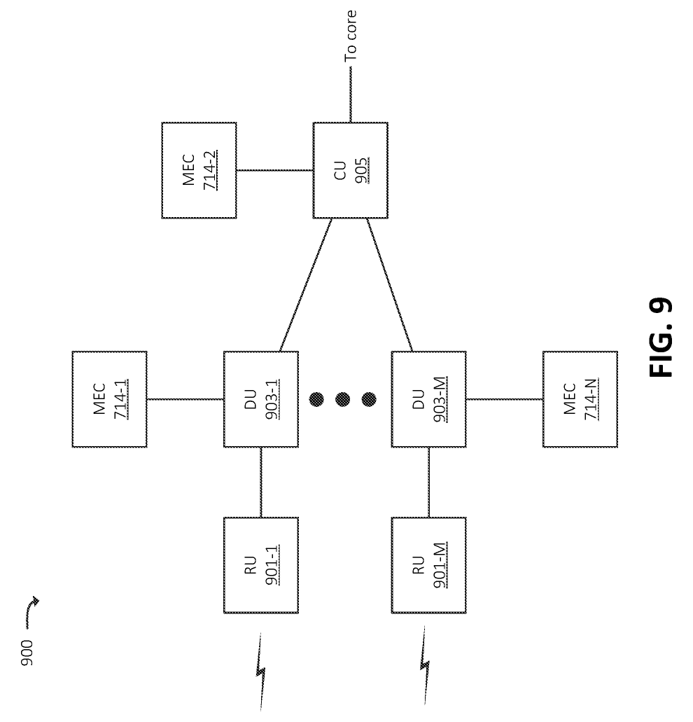

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit ("CU") 905, one or more DUs 903-1 through 903-M (referred to individually as "DU 903," or collectively as "DUs 903"), and one or more RUs 901-1 through 901-M (referred to individually as "RU 901," or collectively as "RUs 901").

CU 905 may communicate with a core of a wireless network (e.g., may communicate with one or more of the devices or systems described above with respect to FIG. 8, such as AMF 715 and/or UPF 805) and/or some other device or system such as MEC 714. In the uplink direction (e.g., for traffic from UEs 701 to a core network), CU 905 may aggregate traffic from DUs 903, and forward the aggregated traffic to the core network. In some embodiments, CU 905 may receive traffic according to a given protocol (e.g., Radio Link Control ("RLC") traffic) from DUs 903, and may perform higher-layer processing (e.g., may aggregate/process RLC packets and generate Packet Data Convergence Protocol ("PDCP") packets based on the RLC packets) on the traffic received from DUs 903.

CU 905 may receive downlink traffic (e.g., traffic from the core network, traffic from a given MEC 714, etc.) for a particular UE 701, and may determine which DU(s) 903 should receive the downlink traffic. DU 903 may include one or more devices that transmit traffic between a core network (e.g., via CU 905) and UE 701 (e.g., via a respective RU 901). DU 903 may, for example, receive traffic from RU 901 at a first layer (e.g., physical ("PHY") layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 701.

RU 901 may include hardware circuitry (e.g., one or more RF transceivers, antennas, radios, and/or other suitable hardware) to communicate wirelessly (e.g., via an RF interface) with one or more UEs 701, one or more other DUs 903 (e.g., via RUs 901 associated with DUs 903), and/or any other suitable type of device. In the uplink direction, RU 901 may receive traffic from UE 701 and/or another DU 903 via the RF interface and may provide the traffic to DU 903. In the downlink direction, RU 901 may receive traffic from DU 903, and may provide the traffic to UE 701 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 701, via a respective RU 901.

For example, DU 903-1 may route some traffic, from UE 701, to MEC 714-1 instead of to a core network via CU 905. MEC 714-1 may process the traffic, perform one or more computations based on the received traffic, and may provide traffic to UE 701 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 701, as traffic does not need to traverse DU 903, CU 905, links between DU 903 and CU 905, and an intervening backhaul network between RAN environment 900 and the core network.

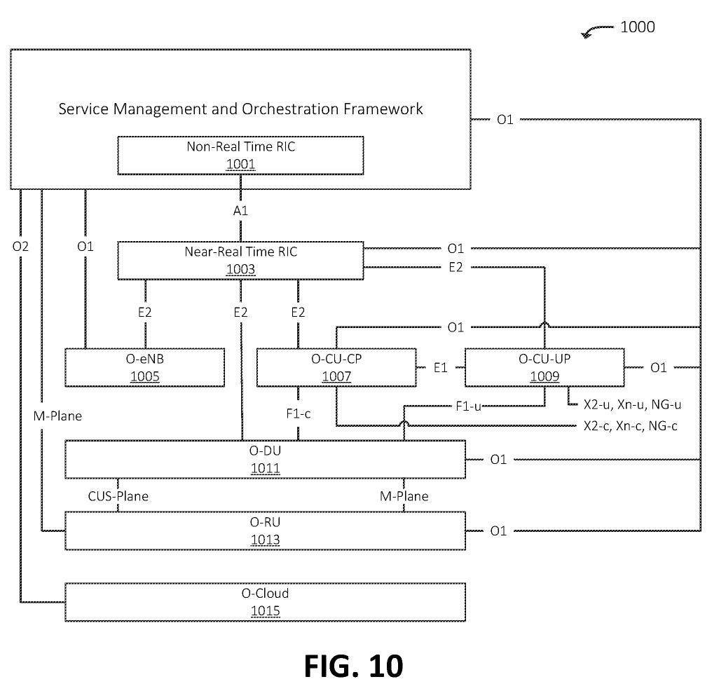

FIG. 10 illustrates an example O-RAN environment 1000, which may correspond to RAN 710, RAN 712, and/or RAN environment 900. For example, RAN 710, RAN 712, and/or RAN environment 900 may include one or more instances of O-RAN environment 1000, and/or one or more instances of O-RAN environment 1000 may implement RAN 710, RAN 712, RAN environment 900, and/or some portion thereof. As shown, O-RAN environment 1000 may include Non-Real Time Radio Intelligent Controller ("RIC") 1001, Near-Real Time RIC 1003, O-eNB 1005, O-CU-Control Plane ("O-CU-CP") 1007, O-CU-User Plane ("O-CU-UP") 1009, O-DU 1011, O-RU 1013, and O-Cloud 1015. In some embodiments, O-RAN environment 1000 may include additional, fewer, different, and/or differently arranged components or interfaces. In some embodiments, a given cell site 103 may be, may include, and/or may be implemented by one or more elements of O-RAN environment 1000.

In some embodiments, some or all of the elements of O-RAN environment 1000 may be implemented by one or more configurable or provisionable resources, such as virtual machines, cloud computing systems, physical servers, and/or other types of configurable or provisionable resources. In some embodiments, configuration information of one or more cell sites 103, referred to above, may include configuration information for one or more elements of O-RAN environment 1000. In some embodiments, some or all of O-RAN environment 1000 may be implemented by, and/or communicatively coupled to, one or more MECs 714, containers, virtual machines, or the like.

Non-Real Time RIC 1001 and Near-Real Time RIC 1003 may receive performance information (and/or other types of information) from one or more sources, and may configure other elements of O-RAN environment 1000 based on such performance or other information. For example, Near-Real Time RIC 1003 may receive performance information, via one or more E2 interfaces, from O-eNB 1005, O-CU-CP 1007, and/or O-CU-UP 1009, and may modify parameters associated with O-eNB 1005, O-CU-CP 1007, and/or O-CU-UP 1009 based on such performance information. Similarly, Non-Real Time RIC 1001 may receive performance information associated with O-eNB 1005, O-CU-CP 1007, O-CU-UP 1009, and/or one or more other elements of O-RAN environment 1000 and may utilize machine learning and/or other higher level computing or processing to determine modifications to the configuration of O-eNB 1005, O-CU-CP 1007, O-CU-UP 1009, and/or other elements of O-RAN environment 1000. In some embodiments, Non-Real Time RIC 1001 may generate machine learning models based on performance information associated with O-RAN environment 1000 or other sources, and may provide such models to Near-Real Time RIC 1003 for implementation.

O-eNB 1005 may perform functions similar to those described above with respect to gNB 711 and/or eNB 713. For example, O-eNB 1005 may facilitate wireless communications between UE 701 and a core network. O-CU-CP 1007 may perform control plane signaling to coordinate the aggregation and/or distribution of traffic via one or more DUs 903, which may include and/or be implemented by one or more O-DUs 1011, and O-CU-UP 1009 may perform the aggregation and/or distribution of traffic via such DUs 903 (e.g., O-DUs 1011). O-DU 1011 may be communicatively coupled to one or more RUs 901, which may include and/or may be implemented by one or more O-RUs 1013. In some embodiments, O-Cloud 1015 may include or be implemented by one or more MECs 714, which may provide services, and may be communicatively coupled, to O-CU-CP 1007, O-CU-UP 1009, O-DU 1011, and/or O-RU 1013 (e.g., via an O1 and/or O2 interface).

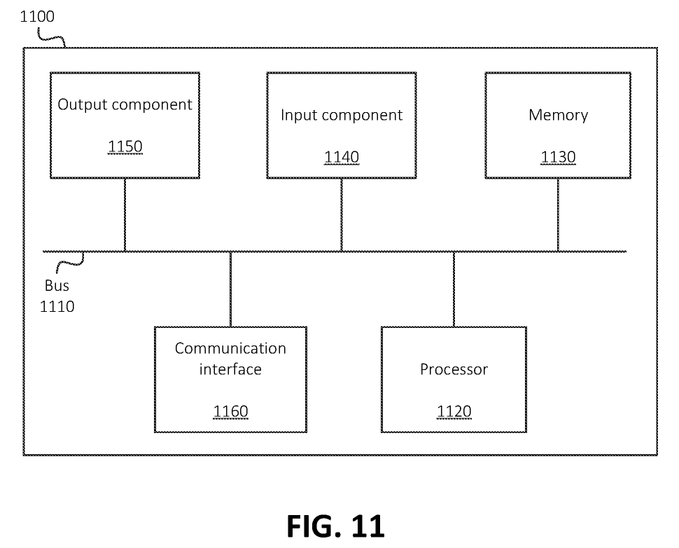

FIG. 11 illustrates example components of device 1100. One or more of the devices described above may include one or more devices 1100. Device 1100 may include bus 1110, processor 1120, memory 1130, input component 1140, output component 1150, and communication interface 1160. In another implementation, device 1100 may include additional, fewer, different, or differently arranged components.

Bus 1110 may include one or more communication paths that permit communication among the components of device 1100. Processor 1120 may include a processor, microprocessor, a set of provisioned hardware resources of a cloud computing system, or other suitable type of hardware that interprets and/or executes instructions (e.g., processor-executable instructions). In some embodiments, processor 1120 may be or may include one or more hardware processors. Memory 1130 may include any type of dynamic storage device that may store information and instructions for execution by processor 1120, and/or any type of non-volatile storage device that may store information for use by processor 1120.

Input component 1140 may include a mechanism that permits an operator to input information to device 1100 and/or other receives or detects input from a source external to input component 1140, such as a touchpad, a touchscreen, a keyboard, a keypad, a button, a switch, a microphone or other audio input component, etc. In some embodiments, input component 1140 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1150 may include a mechanism that outputs information to the operator, such as a display, a speaker, one or more light emitting diodes ("LEDs"), etc.

Communication interface 1160 may include any transceiver-like mechanism that enables device 1100 to communicate with other devices and/or systems (e.g., via RAN 710, RAN 712, DN 750, etc.). For example, communication interface 1160 may include an Ethernet interface, an optical interface, a coaxial interface, or the like. Communication interface 1160 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1100 may include more than one communication interface 1160. For instance, device 1100 may include an optical interface, a wireless interface, an Ethernet interface, and/or one or more other interfaces.

Device 1100 may perform certain operations relating to one or more processes described above. Device 1100 may perform these operations in response to processor 1120 executing instructions, such as software instructions, processor-executable instructions, etc. stored in a computer-readable medium, such as memory 1130. A computer-readable medium may be defined as a non-transitory memory device. A memory device may include space within a single physical memory device or spread across multiple physical memory devices. The instructions may be read into memory 1130 from another computer-readable medium or from another device. The instructions stored in memory 1130 may be processor-executable instructions that cause processor 1120 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
generate a plurality of cell site models that each include respective cell site configuration information and respective cell site Key Performance Indicator ("KPI") information;
score each cell site model, of the plurality of cell site models, based on the KPI information for each cell site model and further based on a plurality of optimization factors, wherein a particular cell site model is associated with at least a first score associated with a first optimization factor and a second score associated with a second optimization factor;
generate a plurality of rankings of the cell site models based on the optimization factors, wherein generating a first ranking of the cell site models includes ranking the particular cell site model based on the first score and wherein generating a second ranking of the cell site models includes ranking the particular cell site model based on the second score; and
implement one or more cell sites of a wireless network according to the plurality of rankings.

2. The device of claim 1, wherein the particular configuration information includes one or more containers of a containerized environment, and wherein implementing the particular cell site of the wireless network includes instantiating the one or more containers.

3. The device of claim 1, wherein implementing the one or more cell sites includes:
receiving a request that includes a particular optimization factor;
comparing the particular optimization factor, included in the request, to the plurality of optimization factors;
selecting, based on the comparing, the first optimization factor;
identifying the first ranking of the cell site models that is associated with the first optimization factor;
selecting the particular cell site model based on the first score associated with the particular cell site model; and
identifying particular configuration information included in the particular cell site model,
wherein implementing the one or more cell sites of the wireless network is based on the identified particular configuration information.

4. The device of claim 3, wherein the configuration information associated with the plurality of cell site models includes hardware resource specifications of each cell site of a plurality of cell sites of the wireless network, wherein the request further includes a set of hardware criteria, wherein selecting the particular cell site model includes determining that the hardware resource specifications associated with the particular cell site model meet the set of hardware criteria included in the request.

5. The device of claim 1, wherein each cell site model, of the plurality of cell site models, is associated with a respective cell site of a plurality of cell sites of the wireless network.

6. The device of claim 1, wherein the one or more cell sites include a base station of a radio access network ("RAN") of the wireless network.

7. The device of claim 6, wherein the base station of the wireless network includes at least one of:
an evolved Node B ("eNB"), or
a Next Generation Node B ("gNB").

8. A non-transitory computer-readable medium, storing a plurality of processor-executable instructions to:
generate a plurality of cell site models that each include respective cell site configuration information and respective cell site Key Performance Indicator ("KPI") information;
score each cell site model, of the plurality of cell site models, based on the KPI information for each cell site model and further based on a plurality of optimization factors, wherein a particular cell site model is associated with at least a first score associated with a first optimization factor and a second score associated with a second optimization factor;
generate a plurality of rankings of the cell site models based on the optimization factors, wherein generating a first ranking of the cell site models includes ranking the particular cell site model based on the first score and wherein generating a second ranking of the cell site models includes ranking the particular cell site model based on the second score; and
implement one or more cell sites of a wireless network according to the plurality of rankings.

9. The non-transitory computer-readable medium of claim 8, wherein the particular configuration information includes one or more containers of a containerized environment, and wherein implementing the particular cell site of the wireless network includes instantiating the one or more containers.

10. The non-transitory computer-readable medium of claim 8, wherein implementing the one or more cell sites includes:
receiving a request that includes a particular optimization factor;
comparing the particular optimization factor, included in the request, to the plurality of optimization factors;
selecting, based on the comparing, the first optimization factor;
identifying the first ranking of the cell site models that is associated with the first optimization factor;
selecting the particular cell site model based on the first score associated with the particular cell site model; and
identifying particular configuration information included in the particular cell site model,
wherein implementing the one or more cell sites of the wireless network is based on the identified particular configuration information.

11. The non-transitory computer-readable medium of claim 10, wherein the configuration information associated with the plurality of cell site models includes hardware resource specifications of each cell site of a plurality of cell sites of the wireless network, wherein the request further includes a set of hardware criteria, wherein selecting the particular cell site model includes determining that the hardware resource specifications associated with the particular cell site model meet the set of hardware criteria included in the request.

12. The non-transitory computer-readable medium of claim 8, wherein each cell site model, of the plurality of cell site models, is associated with a respective cell site of a plurality of cell sites of the wireless network.

13. The non-transitory computer-readable medium of claim 8, wherein the one or more cell sites include a base station of a radio access network ("RAN") of the wireless network.

14. The non-transitory computer-readable medium of claim 13, wherein the base station of the wireless network includes at least one of:
an evolved Node B ("eNB"), or
a Next Generation Node B ("gNB").

15. A method, comprising:
generating a plurality of cell site models that each include respective cell site configuration information and respective cell site Key Performance Indicator ("KPI") information;
scoring each cell site model, of the plurality of cell site models, based on the KPI information for each cell site model and further based on a plurality of optimization factors, wherein a particular cell site model is associated with at least a first score associated with a first optimization factor and a second score associated with a second optimization factor;
generating a plurality of rankings of the cell site models based on the optimization factors, wherein generating a first ranking of the cell site models includes ranking the particular cell site model based on the first score and wherein generating a second ranking of the cell site models includes ranking the particular cell site model based on the second score; and
implementing one or more cell sites of a wireless network according to the plurality of rankings.

16. The method of claim 15, wherein the particular configuration information includes one or more containers of a containerized environment, and wherein implementing the particular cell site of the wireless network includes instantiating the one or more containers.

17. The method of claim 15, wherein implementing the one or more cell sites includes:
receiving a request that includes a particular optimization factor;
comparing the particular optimization factor, included in the request, to the plurality of optimization factors;
selecting, based on the comparing, the first optimization factor;
identifying the first ranking of the cell site models that is associated with the first optimization factor;
selecting the particular cell site model based on the first score associated with the particular cell site model; and
identifying particular configuration information included in the particular cell site model,
wherein implementing the one or more cell sites of the wireless network is based on the identified particular configuration information.

18. The method of claim 17, wherein the configuration information associated with the plurality of cell site models includes hardware resource specifications of each cell site of a plurality of cell sites of the wireless network, wherein the request further includes a set of hardware criteria, wherein selecting the particular cell site model includes determining that the hardware resource specifications associated with the particular cell site model meet the set of hardware criteria included in the request.

19. The method of claim 15, wherein each cell site model, of the plurality of cell site models, is associated with a respective cell site of a plurality of cell sites of the wireless network.

20. The method of claim 15, wherein each cell site, of a plurality of cell sites of the wireless network, includes at least one of:
an evolved Node B ("eNB"), or
a Next Generation Node B ("gNB").
